(19) United States
(12) Patent Application Publication
(10) Pub. No.: US 2014/0122298 A1
(43) Pub. Date: May 1, 2014

(54) Mobile Information Tool System and Method

(71) Applicant: TROY APPS, LLC., Vista, CA (US)

(72) Inventor: Michael Oyer, Escondido, CA (US)

(73) Assignee: Troy Apps, LLC., Vista, CA (US)

(21) Appl. No.: 13/665,851

(22) Filed: Oct. 31, 2012

(51) Int. Cl. G06Q 30/06

(52) U.S. Cl. CPC G06Q 30/0601; G06F 8/60
USPC 705/26.62; 717/101

(57) ABSTRACT

A mobile information application is generated for use with a mobile information tool on a mobile computing device platform. A reader framework for integrating with one or more platform-independent documents is generated from a platform-independent document generator, and the platform-independent documents are imported into an integrated development environment project. A mobile information application is generated with an application generator from the integrated development environment project, and deployed on one or more mobile computing devices associated with the mobile computing device platform.

### TECHNICAL FIELD

The subject matter described herein relates to mobile computing, and more particularly to a mobile information tool system and method, such as a mobile sales tool module.

### BACKGROUND

With the emergence of mobile computing platforms, such as tablet computers and mobile smart phones, more commerce is being executed on such mobile computing platforms. However, commercial activities are typically conducted on a particular HTML website using conventional web-based browsing of a catalog of products. Conventional web-based browsing can be fragmented due to the mobile computing platform having to communicate via the internet in order to retrieve and send information to particular HTML websites. As a result, the content and user experiences of selecting, ordering, purchasing, etc., can be of lower quality and time consuming. For example, the mobile application through which a user can display a catalog of products is typically not integrated with any backend management software.

Further, existing catalog solutions can be limited and rely on an internet connection to download streaming media to demonstrate the product. This can be constrained at times, leading to a rough and halting visual experience by a potential buyer. In addition, lag time or loss in wireless connections can occur during attempts to upload media onto the mobile platforms which can disrupt the viewer's experience and create frustrations. Particularly in situations where a product is being shown to a potential buyer, disruptions and/or delays in displaying product information can potentially ruin a sale.

There are also limitations with having stored catalogues on a mobile computing platform. Some of these limitations include the inability of the stored catalogues to be updated and modified with information relating to at least the products contained in the catalogues. Therefore, a seller may not be updated with current design changes, product availability or product information that would be beneficial for either the buyer or seller to have access to.

The details of one or more embodiments of a mobile information tool module, such as a mobile sales tool module, are set forth in the accompanying drawings and the description below. Other features and advantages will be apparent from the description and drawings, and from the claims.

### SUMMARY

In one aspect, a method is presented, for generating a mobile information application for use with a mobile information tool on a mobile computing device platform. The method includes generating a reader framework for integrating with one or more platform-independent documents from a platform-independent document generator, and importing the platform-independent documents into an integrated development environment project based on an operating system of the mobile computing device platform. The method further includes generating a mobile information application with an application generator from the integrated development environment project, and deploying, with a deployment module, the mobile information application to the mobile information tool on one or more mobile computing devices associated with the mobile computing device platform.

In another aspect, a mobile information tool builder is presented for creating and deploying a mobile information application. The mobile information tool builder includes a reader framework generator for generating a reader framework for integration with one or more platform-independent documents from a platform-independent document generator in an integrated development environment (IDE) project generator. The mobile information tool builder further includes an application generator for forming the project from the IDE project generator into a mobile information application, and a deployment module for deploying the mobile information application generated by the application generator to one or more mobile computing devices through a wireless communication network.

Implementations of the current subject matter can include, but are not limited to, systems and methods consistent with the implementations described herein, including one or more features are described, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

These and other aspects will now be described in detail with reference to the following drawings.

FIG. 1 illustrates a block diagram of a mobile information tool builder to generate information applications.

FIG. 2 illustrates a block diagram of a standard process for creating and deploying a newly created information application with a mobile information tool builder.

FIG. 3 depicts a block diagram of an initial processing that occurs at application startup.

FIG. 4 is a functional block diagram of the modules that make up a mobile information tool on a tablet computer.

FIG. 5 illustrates a mobile device manager including a full-featured assets manager.

FIG. 6 illustrates an example screen shot showing a mobile device manager custom document creator creating a custom document.

FIG. 7 illustrates an example of data access objects and their relationships within a mobile device manager.

Like reference symbols in the various drawings indicate like elements.

### DETAILED DESCRIPTION

The mobile information tool disclosed herein includes a tablet computer-based mobile sales management and product catalog tool designed for a touch-sensitive display-controlled tablet computer, such as the iPad by Apple, Inc. In some implementations, the mobile information tool is configured specifically for the iPad. The mobile information tool takes advantage of modern tablet computers' features, including a vivid display for images, high-resolution audio and video, computer animation, networking, and geolocation, and other capabilities, in order to provide an intuitive and productive remote informational tool for use by sales persons, educators, or others.

The mobile information tool includes at least the following capabilities: instant and accurate order submission to the central office, the ability to use high-resolution video and images when demonstrating a company's products or services, managing an order's status or other client information, as well as many other tasks performed every day by sales men and women.

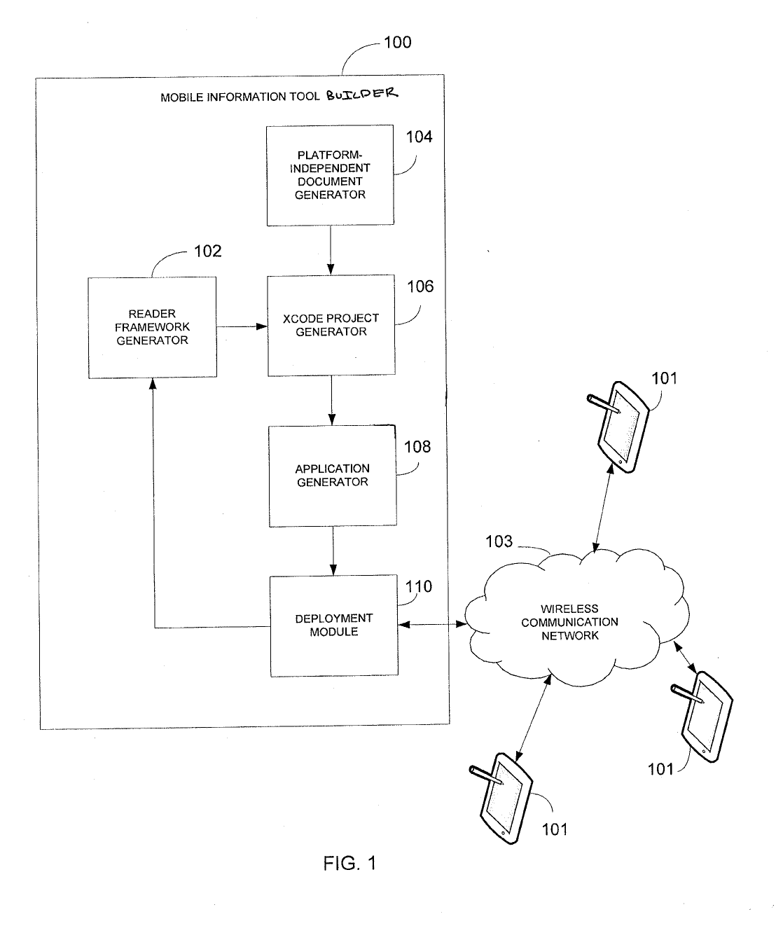

FIG. 1 is a block diagram of a mobile information tool builder 100 that can be used to generate information applications for use with a mobile information tool. The mobile information tool builder 100 can include an integrated set of frameworks and modules that can be easily customized and configured for the specific requirements of any client. Many aspects of the mobile information tool can be easily configured by simply modifying property list files and building a new version of the information application. Each individual module's look and feel can be configured using a set of pre-defined templates or using artwork and design files, including those provided by a user.

The mobile information tool builder 100 can include a reader framework generator 102 to generate a reader framework for integration with one or more platform-independent documents from a platform-independent document generator 104 in an integrated development environment (IDE) application project generator 106. The IDE application project generator 106 generates an IDE project. The IDE application project generator includes a suite of software development tools for generating applications for a particular mobile computing device platform, such as tablet computing device platforms like the Apple iPad platform. In the case of the iPad platform, the IDE application project generator 106 is an XCode project generator, and the XCode project generator generates an XCode project based on an operating system (iOS) of the iPad platform.

The platform-independent documents can be in the form of Portable Document Files (PDFs) or other platform-independent format or protocol. Once the reader framework and the platform-independent document(s) are imported into the IDE project, the resultant project can be formed into a mobile information application by application generator 108, and then deployed by deployment module 110 to any number of mobile computing devices 101 via a wireless communication network 103.

The wireless communication network 103 can be any wireless or cellular data network, and may also include any number of wired communication networks or infrastructure. The mobile information tool builder 100 can generate a mobile information tool and the information applications for tablet computers 101. Alternatively or in addition, the mobile information tool builder 100 can update or modify already deployed information applications in at least near real-time. The mobile information tool builder 100 can generate information applications through the use of block diagrams and class notation that implements a simplified version of UML (Uniform Modeling Language), a standardized design language for object-oriented programming in various languages.

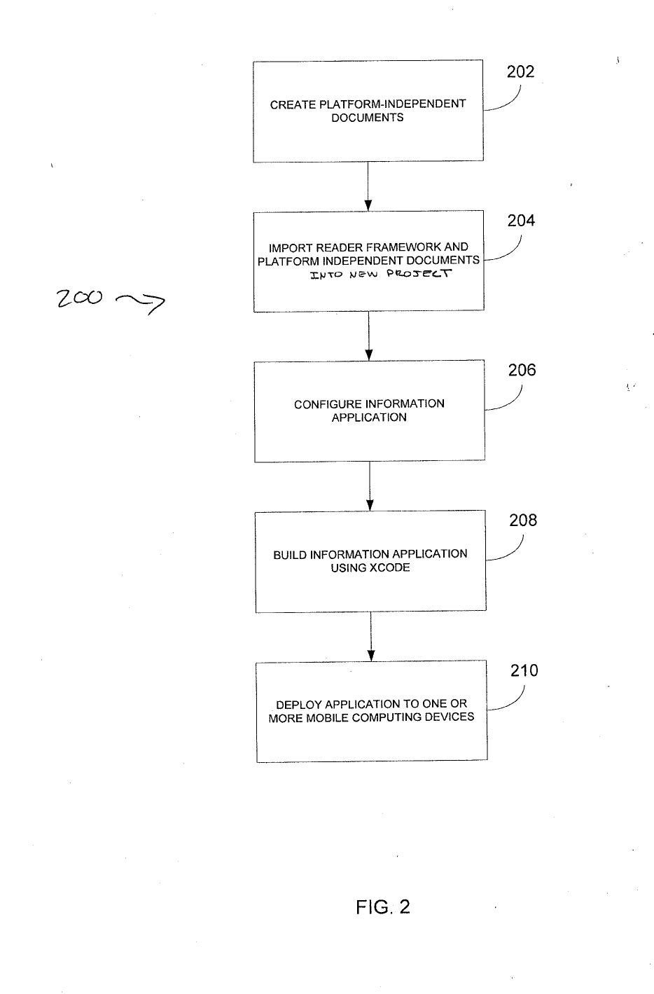

FIG. 2 depicts a block diagram of an implementation of a method for creating and deploying a newly created information application with a mobile information tool builder 200. While the exemplary method is specific to an iPad platform, it should be understood that the general process described in the method can be implemented with any mobile computing device platform, if that platform also includes a requisite IDE application project generator. At 202, platform-independent documents can be created. Next, at 204, an Xcode project can be created and the reader framework imported. Once the project is created, any PDF-formatted document(s) can be added to the project for display. The platform-independent documents can be created using any of a number of other commonly available document creation tools. At 206, the information application can be configured, such as with colors, border widths, etc. At 208, the information application can be built using the XCode project. At 210, the information application can be deployed to one or more tablet computers, cellular devices or other mobile computing devices.

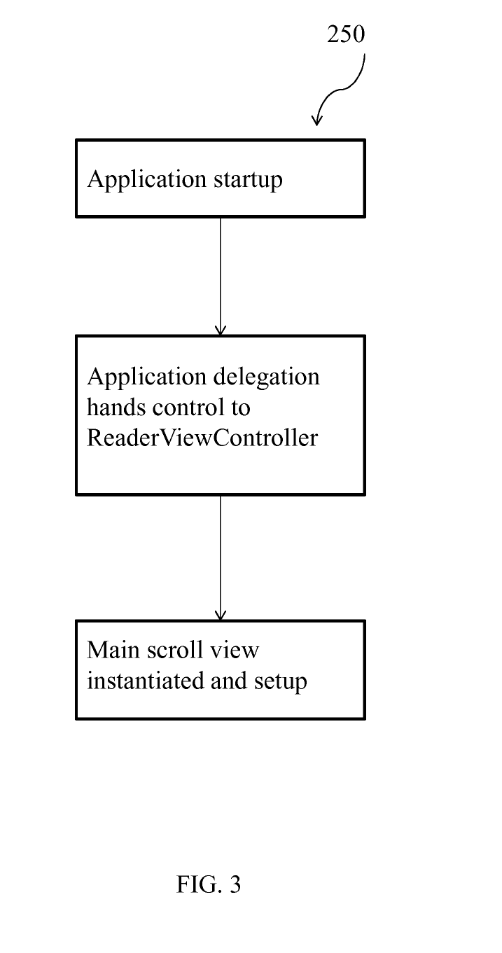

FIG. 3 depicts a block diagram of an initial processing 250 that can occur at application startup. The application delegation can hand control off to a viewer module, such as a ReaderViewController, which can be the main view controller for the information application. Once responsibility is delegated to the ReaderViewController the main scroll view can be instantiated and setup, such as before the app begins.

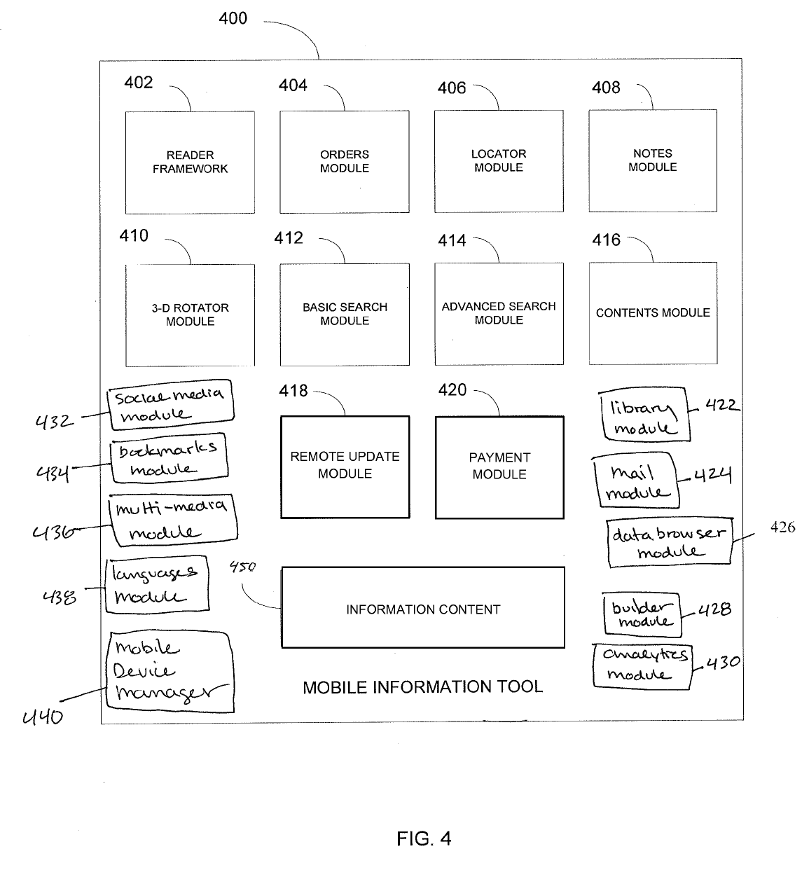

FIG. 4 is a block diagram of an implementation of a mobile information tool 400 for use on a mobile computing device, such as an iPad. The mobile information tool 400 can include a reader framework 402, an orders module 404, a locator module 406, a notes module 408, a three-dimensional (3D) rotator module 410, a basic search module 412, and an advanced search module 414. The mobile information tool 400 can further include a contents module 416, a remote update module 418, a payment module 420, and information content 450 prepared by the mobile information tool builder, such as described above (see also FIG. 1), and on which one or more of the modules of the mobile information tool 400 operates. Additionally, the mobile information tool 400 can include a library module 422, a mail module 424, a data browser module 426, a builder module 428, an analytics module 430, a social media module 432, a bookmarks module 434, a multi-media module 436, a languages module 438, and a mobile device manager 440, as will be discussed in greater detail below.

The reader framework 402 can allow viewing of images and data from the information content 450, for catalogs of virtually any size, forward and backward page swipe, zoom and restore and other display controls and manipulations. For instance, a double-tap on a screen of the tablet computer via the reader framework can cause the display to zoom in by 50% incrementally up to 400%, while a two-finger tap instantly restores to 100% resolution. The reader framework 402 can use a high-resolution platform-independent document-based vector graphics, and high-performance page preloading and display. For example, in some implementations, the reader framework 402 supports PDF thumbnail image extraction.

The reader framework 402 can provide wireless print management of catalogs and individual pages, and scrollable thumbnails for navigation by page, product or other criteria. The reader framework 402 can also provide fast navigation to any section of the catalog with fast and flexible search capabilities. The reader framework 402 can also enable easy configuration of look and feel (i.e., colors, thumbnail sizes, page margins, etc.). The reader framework 402 can provide easy integration and configuration with all other modules of the system.

Catalogs may be downloaded and/or selected from multiple catalogs, and product pages can be bookmarked for quick and easy access, via the reader framework 402. The reader framework 402 can also allow catalogs and other information to be encrypted and secured. The reader framework 402 can be configured to be usable when network access is limited or non-existent.

The display and management of pages of each information application can start with one or more high-resolution files in the platform-independent document format. Once the platform-independent document files are created, they can be imported into a given Xcode project.

The orders module 404 can manage clients, products and orders, allowing a sales person to take and submit orders using only the mobile information tool 400 and information application on the tablet computer. An order may be written up, reviewed, approved and submitted, either via email or by network transfer directly to a company's back-end database system. The orders module 404 can provide a secure, reliable and fast database engine for managing customers, products and orders as well as other sales information. The orders module 404 can also provide a signature pad for receiving a signature after approving an order. Each signature can include metadata indicating the precise date and time of signing, along with latitude and longitude and IP address of the device.

The orders module 404 can further provide reliable and secure transmission of completed orders using standard network protocols, SSL data encryption and valid security certificates. In addition, the orders module 404 can provide easy customization for different types of products and orders. Existing product attributes such as weight, size and color can be easily modified or new ones may be added through the orders module 404. Order pages can be customized or modified using existing templates.

The orders module 404 can provide an ability to choose from a number of different order page templates and navigation styles depending on which style works best for the client's products. Login and password credentials can be optionally required for authentication (using 256-bit high-strength encryption, for example). Finally, the orders module 404 can provide a shopping cart for managing orders. Users can add items to their shopping cared and/or view items in their cart. In addition, users can arrange shipping, billing and payment options. The shopping cart and orders module 404 can be integrated with all major payment services, such as credit issuers, online payment services, and the like.

The locator module 406 can provide instant access to geographic information for stores, dealers or other types of mapping information available with a mapping service, such as Google Maps. The locator module 406 can include search and retrieve geo-location information specific to a sales person (such as a sales route), and generates color-coded pins to provide additional information about various categories of locations. The locator module 406 can provide start/destination mapping, and/or location and mapping of nearest dealers or stores related to the information application or catalog.

The notes module 408 can be used to manage notes of daily activities and can be configured for allowing annotation of any page of a catalog (either hand-written using a stylus for the touch screen interface of the tablet computer, or by using the keyboard), and in turn sending the annotated image as an email. The notes module 408 can include a keyboard or stylus input which can enable a user to write notes and annotate product images using various colors and pens. Notes can be date and time stamped by the notes module 408 and can be stored as information content 450. The handwritten annotations can be loaded and saved for email to customers.

The 3D rotator module 410 can provide a high-definition three-dimensional view of objects, such as products. Still images of a given product can be rotated clockwise and counter clockwise at various speeds to view a product from different angles. The 3D rotator module 410 can provide smooth and accurate rotation around one or more axis, and variable-speed or manual image rotation. In addition, any axis, such as the x, y or z axis, of any object can be manipulated or angled in any direction to enable a variety of angled views of the objects. The 3D rotator module can handle high-resolution images of any size.

The basic search module 412 can provide basic keyword search capabilities. The advanced search module 414 can provide a more advanced search system that can search for words or phrases throughout platform-independent documents (catalogs) and can include a small heads-up display that can be useful for navigating through search results.

The contents module 416 can provide a “drill-down” mechanism for navigating and browsing a catalog of objects, such as products. The products can make up a catalog which can be subdivided into various categories. By using a contents browser included with the contents module 416, the mobile information tool 400 can be configured to allow users to drill-down into product categories in a number of ways.

The remote update module 418 can be used to “push” modifications and additions to an existing catalog already deployed to a tablet computer. Images, text, descriptions, prices and other data can be updated remotely via a web-based system that can schedule updates to sales persons' tablet computers at regular intervals or on-demand. The remote update module 418 can provide a remote updating of catalog and product information, as well as a Web services (REST-based) XML communication mechanism for authentication and transaction management. The remote update module 418 can provide multi-factor authentication for secure transactions, and can wipe or eliminate data on-demand.

The payment module 420 can be used for validation and acceptance of major credit cards or other payment systems, turning the tablet computer into a Point-of-Sale (POS) system. Images, descriptions, prices and other data can be updated remotely via a web-based system that can configured to schedule updates to a sales persons' tablet computer, either at regular intervals or on-demand.

The payment module 420 can be easily integrated and compatible with all credit card payment processors and payment gateways. The payment module 420 can also provide a card reader that can connects directly to the tablet computer, and which can handle card swiping or reading. The payment module 420 can be equipped with data encryption, and can be integrated with an email in order to wirelessly send receipts. In one implementation, the payment module 420 can email HTML-formatted receipts.

The library module 422 can be used for displaying a menu showing available documents, such as PDF documents, to choose from on the mobile computing device. Any number of documents can be stored locally on the mobile computing device. From the menu displayed by the library module 422, any of the documents can be quickly selected and displayed. The library module 422 can arrange and organize the documents into a variety of ways. For example, the library module 422 can either be pre-programmed to arrange and organize documents in one or more ways, or a user can customize the library module 422 to arrange and organize documents in certain ways. Furthermore, documents can be added or modified either remotely via the mobile device manager 440, or documents can be added or modified directly on the mobile device.

The mail module 424 can allow the formatting and sending of email, including the attaching of graphic images, PDF documents, spreadsheets, etc. The mail module 424 can also format a document, such as a PDF page, into a graphic, including resizing the graphic to an appropriate size.

The database browser module 426 can be used to create, read, update and delete database records maintained in the on-board database. This module can be used for data verification, testing of order processing and other tasks. The interface can improve the ability to modify data on-the-fly.

The builder module 428 can allow a user to create custom documents by selecting pages or products from a master list of all the items available, such as from multiple documents and catalogues; including from the menu provided by the library module 422. Once items are selected into the builder module 428, a customized presentation can be built and made available for display, printing or email.

The analytics module 430 can provide tracking and arbitrary app use details. For example, the analytics module 430 can track a user's actions using a custom reporting service, such as Google Analytics. The analytics module 430 can log the actions, inactions or sequence of actions of any user. In addition, usage can be tracked and categorized based on individual users.

The social media module 432 allows integration of the app with any number of a variety of social media outlets (i.e., Facebook, Twitter, and others). This can allow one or more users of the mobile sales tool device to be integrated with various social media outlets.

The bookmarks module 434 can allow the user to save favorite locations found within the app. For example, once a bookmark has been saved, pages can be searched while a bookmark of the page is made available. A user can simply click on any of the bookmarks to return to any one of the bookmarked pages.

The multimedia module 436 can allow media (i.e., audio, video, and various other formats) to be included in an information application. In addition, the multimedia module 436 can specify where and when the media can play.

The languages module 438 can provide support for internationalization and localization. Therefore, the languages module 438 and allow the mobile information tool 400 to be used in any of a number of different languages. For example, any and all phrases in the application can be converted to different languages.

Some implementations of the mobile information tool 400 can include a mobile device manager 440 which can combine the functionality of a content management system, a mobile device manager and a digital asset manager into a single Web 2.0 application that is designed to maintain and update the various assets (i.e., catalogs, technical documents, images, audio, video, product data and other types) that are kept on a user's mobile computing device. In addition, the mobile device manager 440 can provide an easy way to create custom documents (i.e., catalogs, technical documents, product data and any other types of documentation) from existing PDF files. FIG. 6 illustrates an example screen shot showing a mobile device manager custom document creator creating a custom document 445. Once a custom document is created, the custom document can be instantly sent out to any iOS devices that have previously registered for notifications of updates. These notifications can be sent to iOS devices virtually anywhere, such as via wirelessly over the internet. Once the user receives the notification, the user can receive and display the updated or added document(s), or any other assets.

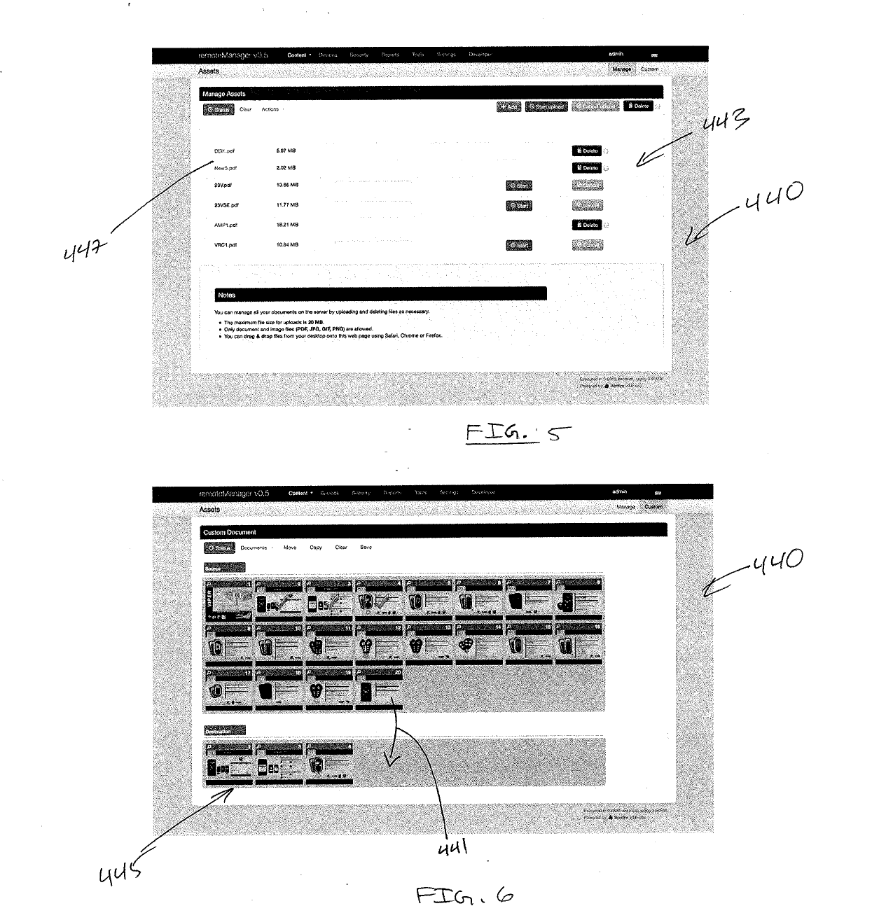

A shown in FIG. 5, some of the features of the mobile device manager 440 can include a full-featured asset manager 443 for assets 447 that can include PDF documents, videos and product data. In addition, the mobile device manager 440 can provide full reporting capabilities, and fast and intuitive navigation. As discussed above and shown in FIG. 6, the mobile device manager 440 can allow custom documents 445 to be easily created using drag and drop 441 by the user. The layout of the mobile device manager 440 can be easily configurable for a unique look and feel. The mobile device manager 440 can provide updates which can be scheduled for deployment at any time in the future. Additionally, the mobile device manager 440 capabilities can include remote password management, remote app management, remote wipe and lock and all other Apple mobile device manager protocol features.

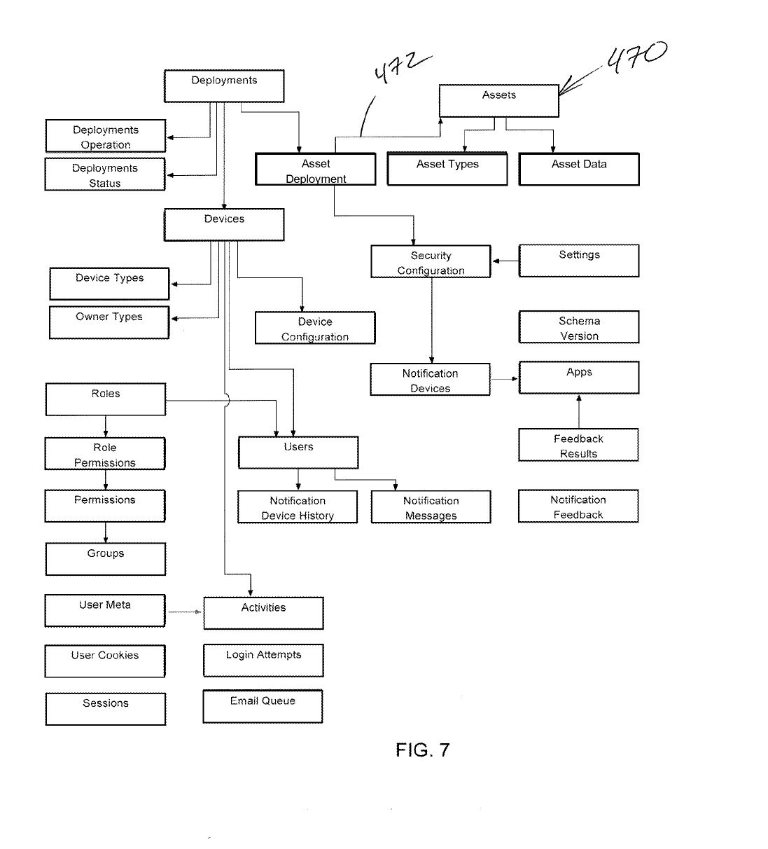

FIG. 7 illustrates an example of data access objects 470 and their relationships 472 within a mobile device manager 440. The programmable system or computing system may include clients and servers. A client and server can be remote from each other and can interact through a communication network. The relationship of client and server can arise by virtue of computer programs running on respective computers and having a client-server relationship to each. other.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method of generating a mobile information application for use with a mobile information tool on a mobile computing device platform, the method comprising:
generating a reader framework for integrating with one or more platform-independent documents from a platform-independent document generator;
importing the platform-independent documents into an integrated development environment project based on an operating system of the mobile computing device platform;
generating a mobile information application with an application generator from the integrated development environment project; and
deploying, with a deployment module, the mobile information application to the mobile information tool on one or more mobile computing devices associated with the mobile computing device platform.

2. The method of claim 1, wherein deploying with a deployment module the information application to one or more mobile computing devices includes sending the information applications through a wireless communication network to one or more mobile computing devices.

3. The method of claim 2, wherein sending the information applications through a wireless communication network to one or more mobile computing devices includes at least one or more of a wireless or cellular data network, or any number of wired communication networks or infrastructure.

4. The method of claim 1, wherein generating and deploying information application to one or more mobile computing devices in at least near real-time.

5. The method of claim 1, further comprising updating deployed information applications in at least near real-time.

6. The method of claim 1, further comprising modifying deployed information applications in at least near real-time.

7. A method for creating and deploying a newly created information application for use with a mobile information tool comprising:
creating a platform-independent document;
importing a reader framework into a mobile information tool builder;
creating an XCode project in the mobile information tool builder;
configuring the information application with the XCode project;
building the information application with the XCode project; and
deploying the information application to one or more mobile computing devices.

8. The method of claim 7, further comprising adding one or more documents to the XCode project.

9. The method of claim 7, wherein deploying the information application to one or more mobile computing devices includes one or more cellular devices and tablet computers.

10. A mobile information tool builder for creating and deploying a mobile information application comprising:
a reader framework generator for generating a reader framework for integration with one or more platform-independent documents from a platform-independent document generator in an integrated development environment (IDE) project generator;
an application generator for forming a project from the IDE project generator into a mobile information application; and
a deployment module for deploying the mobile information application generated by the application generator to one or more mobile computing devices through a wireless communication network.

11. The mobile sales tool builder of claim 10, further comprising an integrated set of customizable frameworks and modules by a user.

12. The mobile sales tool builder of claim 10, further comprising any number of wireless or cellular data networks, wired communication networks or infrastructures.

13. A mobile information tool comprising:
a reader framework for viewing images and data on the mobile information tool;
an orders module for managing one or more of a client, product and order;
a locator module for providing instant access to geographic information;
a notes module having a keyboard or stylus for user entry of notes;
a three dimensional rotator module for providing a high-definition three-dimensional view of an object;
a basic search module for providing basic keyword searches and an advanced search module for providing more advanced searches throughout the platform-independent documents;
a remote update module for remotely updating data on one or more mobile computing devices, including a mechanism for authentication and transaction management;
a payment module for validating and accepting payment;
a database browser module for at least one of creating, reading, deleting and updating database records maintained on an on-board database;
an analytics module for providing tracking and arbitrary use details;
a bookmarks module for saving favorite locations found within an information application;
a multimedia module for allowing media to be included in an application; and
a mobile device manager for maintaining and updating various assets stored on the mobile information tool.

14. The mobile information tool of claim 13, wherein the orders module includes a shopping cart for managing orders.

15. The mobile information tool of claim 13, wherein the remote update module includes a multi-factor authentication for secure transactions.

16. The mobile information tool of claim 13, wherein the mobile device manager includes an assets manager.

17. The mobile information tool of claim 13, wherein the mobile device manager includes a custom document creator.

18. The mobile information tool of claim 13, further comprising a contents module for providing a drill-down mechanism for navigating and browsing a catalog of objects.

19. The mobile information tool of claim 13, further comprising a library module for displaying a menu showing available documents to choose from within the mobile information tool.

20. The mobile information tool of claim 13, further comprising a mail module for formatting and sending email.

21. The mobile information tool of claim 13, further comprising a builder module for creating custom documents by selecting pages or products from a master list.

22. The mobile information tool of claim 13, further comprising a social media module for integrating any number of a variety of social media outlets.

23. The mobile information tool of claim 13, further comprising a language module for allowing the mobile information tool to be used in any of a number of different languages.
